(19) United States
(12) Patent Application Publication
(10) Pub. No.: US 2005/0047886 A1
(43) Pub. Date: Mar. 3, 2005

(54) Guide clamp system for fraise

(76) Inventors: Hsu Hsiu-Kwei Liu, Yuan City (TW); Ming-Hsiang Chiu, Chia Yi City (TW)

Correspondence Address: Alan D. Kamrath;Rider Bennett, LLP, Suite 2000, 333 South Seventh Street, Minneapolis, MN, 55402, US

(21) Appl. No.: 10/653,545

(22) Filed: Sep. 2, 2003

(51) Int. Cl. B23D 7/08

(52) U.S. Cl. 409/219

(57) ABSTRACT

A guide clamp system includes at least two guide clamps and two connectors. The at least two guide clamps are connected with each other by means of two connectors. One of the guide clamps includes a body, a stationary jaw, a movable jaw assembly, a rod and a lever. The stationary jaw is secured to the body for contact with an edge a workpiece. The movable jaw assembly is movable on the body for contact with an opposite edge of the workpiece. The rod is movably attached to the body and inserted through the stationary jaw and the movable jaw assembly for selectively moving the movable jaw assembly. The lever is pivotally connected with the rod for moving the rod.

### FIELD OF INVENTION

The present invention relates to a guide clamp system for a fraise.

### BACKGROUND OF INVENTION

FIGS. 8 and 9 show a conventional guide clamp 70 for use with a hand held fraise. The guide clamp 70 includes a body 72 that is secured to a workbench in use. A workpiece 80 is put on top of the body 72. A workpiece 82 is put on a side of the body 72. A fraise guide 74 is put on the workpiece 80. A clamping device 76 is used to clamp the fraise guide 74 and the workpiece 80 to the body 72. A clamping device 78 is used to clamp the workpiece 82 to the body 72. In operation, a user moves a hand held fraise to the workpieces 80 and 82 clamped to the guide clamp 70. As secured to the workbench, i.e., not movable on the workbench, the guide clamp 70 cannot be used together with a stationary fraise that is not movable on the workbench.

The present invention is therefore intended to obviate or at least alleviate the problems encountered in prior art.

### SUMMARY OF INVENTION

It is the primary objective of the present invention to provide a clamp guide system for use together with hand held and stationary fraises.

According to the present invention, a guide clamp system includes at least two guide clamps and two connectors. The at least two guide clamps are connected with each other by means of two connectors.

Other objects, advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1 is a perspective view of a guide clamp system for keeping two workpieces on a workbench according to a first embodiment of the present invention.

FIG. 2 is an enlarged perspective view of the guide clamp system of FIG. 1.

FIG. 3 is an exploded view of the guide clamp system of FIG. 2.

FIG. 4 is a cross-sectional view of the guide clamp of FIG. 2.

FIG. 5 is a perspective view of a guide clamp system according to a second embodiment of the present invention.

FIG. 6 is a perspective view of a guide clamp system according to a third embodiment of the present invention.

FIG. 7 is a perspective view of a guide clamp system according to a fourth embodiment of the present invention.

FIG. 8 is a perspective view of a conventional guide clamp for use with a hand held fraise.

FIG. 9 is an enlarged perspective view of a body of the conventional guide clamp of FIG. 8.

### DETAILED DESCRIPTION OF EMBODIMENTS

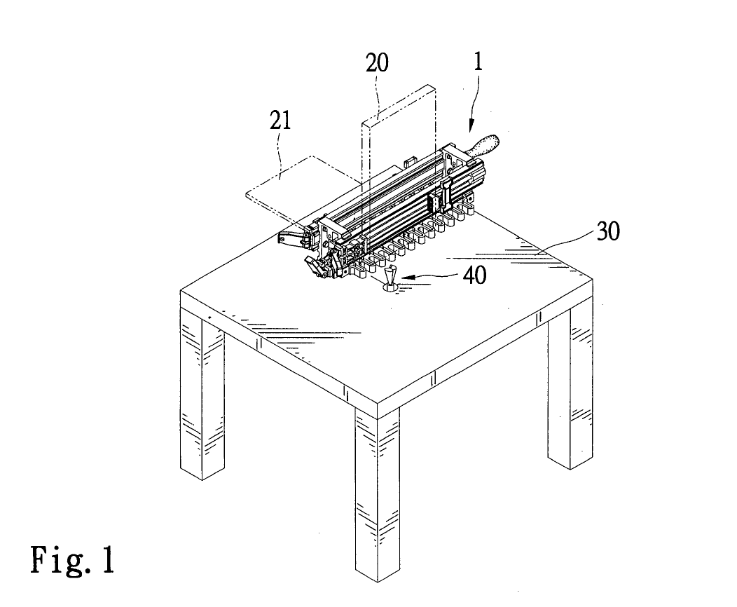

Referring to FIG. 1, two workpieces 20 and 21 are held together by means of a guide clamp system 1 according to a first embodiment of the present invention. The workpieces 20 and 21 are perpendicular to each other. The workpieces 20 and 21 and the guide clamp system 1 are put on a miller (not numbered).

The miller includes a workbench 30 and a fraise 40 installed on the workbench 30. The fraise 40 makes dovetails on a workpiece such as the workpieces 20 and 21 by means of milling. Via moving the guide clamp system 1, a user moves the workpieces 20 and 21 to the fraise 40 so that the fraise 40 cuts into the workpiece 20 before the workpiece 21. Dovetail recesses are defined in the workpiece 20, and a dovetail is formed between adjacent two of the dovetail recesses. Dovetail recesses are defined in the workpiece 21. Since the fraise 40 cuts sequentially into the workpieces 20 and 21, the dovetails of the workpiece 20 fit well in the dovetail recesses of the workpiece 21.

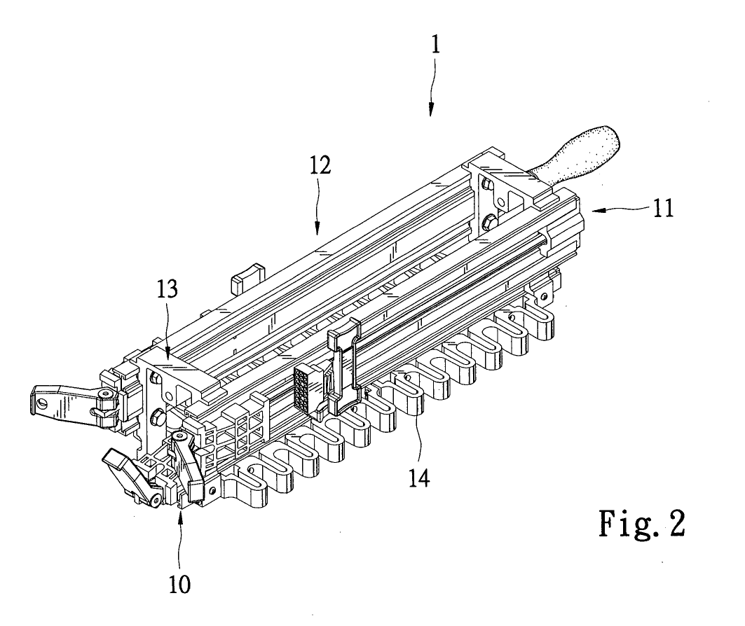

Referring to FIG. 2, the guide clamp system 1 includes three guide clamps 10, 11 and 12 and two connectors 13 for connecting the guide clamps 10, 11 and 12 with one another. A fraise guide 14 is attached to the guide clamp 10 by means of fasteners. A handle (not numbered) is attached to one of the connectors 13.

Each of the guide clamps 10, 11 and 12 may be any proper conventional guide clamp or that is disclosed in the applicant's co-pending application Ser. No. 10/634,191 filed on Aug. 4, 2003 and incorporated herein. The guide clamps 10, 11 and 12 are identical to one another in the first embodiment; however, they may be different from one another in some other embodiments.

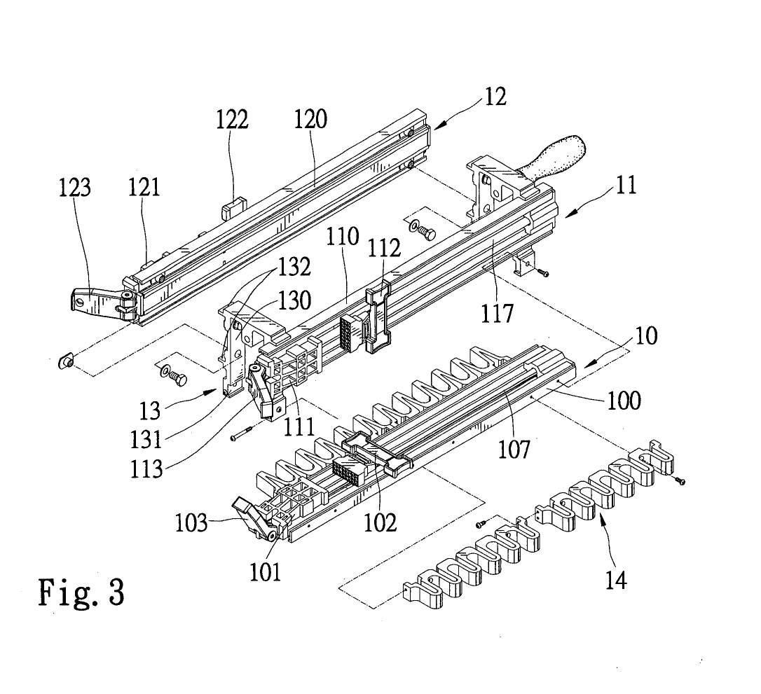

Referring to FIG. 3, the guide clamp 10 has a body 100, a stationary jaw 101, a movable jaw assembly 102, a rod 107 and a lever 103.

The stationary jaw 101 is secured to the body 100 for contact with an edge of the workpiece 21.

The movable jaw assembly 102 is movable on the body 100 for contact with an opposite edge of the workpiece 21.

The rod 107 is movably attached to the body 100 and inserted through the stationary jaw 101 and the movable jaw assembly 102. The rod 107 can selectively move the movable jaw assembly 102.

The lever 103 is pivotally connected with the rod 107. At an end of the lever 103 is formed a cam (not numbered) for contact with the stationary jaw 101. Thus, pivotal of the lever 103 and the contact of the cam with the stationary jaw 101 cause movement of the rod 107 along the body 100. The movement of the rod 107 can cause movement of the movable jaw assembly 102 so as to clamp the workpiece 21. Further details of the movable jaw 102 will not be given for being conventional.

Similarly, the guide clamp 11 includes a body 110, a stationary jaw 111 for contact with an edge of the workpiece 20, a movable jaw assembly 112 for contact with an opposite edge of the workpiece 20, a rod 117 and a lever 113.

Similarly, the guide clamp 12 includes a body 120, a stationary jaw 121, a movable jaw assembly 122, a rod 127 and a lever 113.

Each of the connector 13 includes a central member and two lateral members 130 extending from the central member. Each of the lateral members 130 defines a recess 131 for receiving an edge of the body 100. Each of the lateral members 130 includes two tabs 132 formed thereon. The tabs 132 of one lateral member 130 and the tabs 132 of the other lateral member 130 extend in opposite directions. The tabs 132 of one lateral member 130 preferably extend away from the tabs 132 of the other lateral member 130. The body 110 is put between the tabs 132 of one lateral member 130, and the body 120 is put between the tabs 132 of the other lateral member 130.

The bodies 100, 110 and 120 are secured to the connectors 13 by means of fasteners (not numbered).

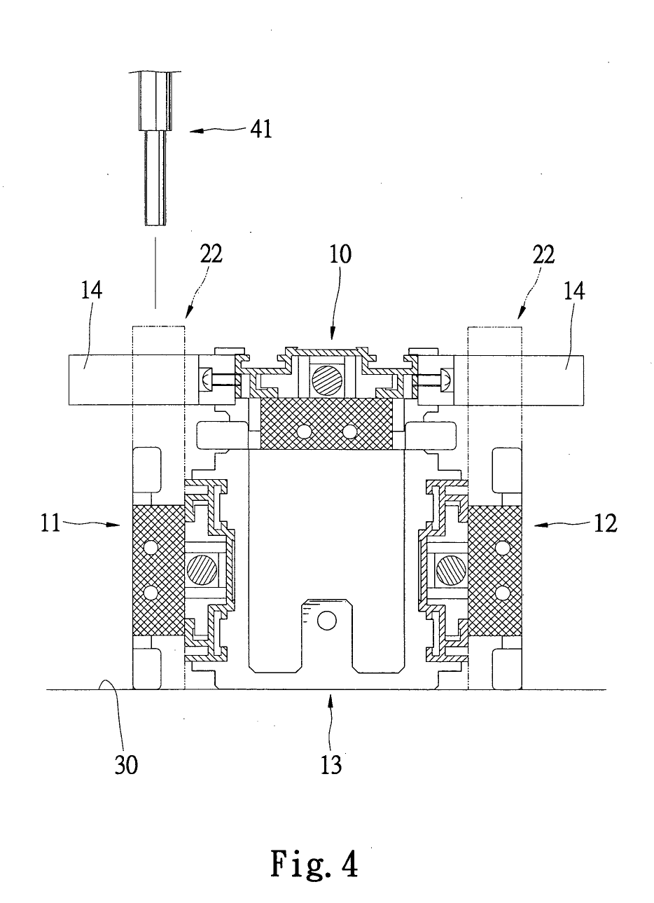

Referring to FIG. 4, the guide clamp system 1 is inverted compared with what is shown in FIGS. 1-3. The central members of the connectors 13 are put on the workbench 30. A workpiece 22 is clamped by means of the guide clamp 11. Another workpiece 22 is clamped by means of the guide clamp 12. A tool 41 such as a fraise and a drill can be operated to work on the workpieces 22.

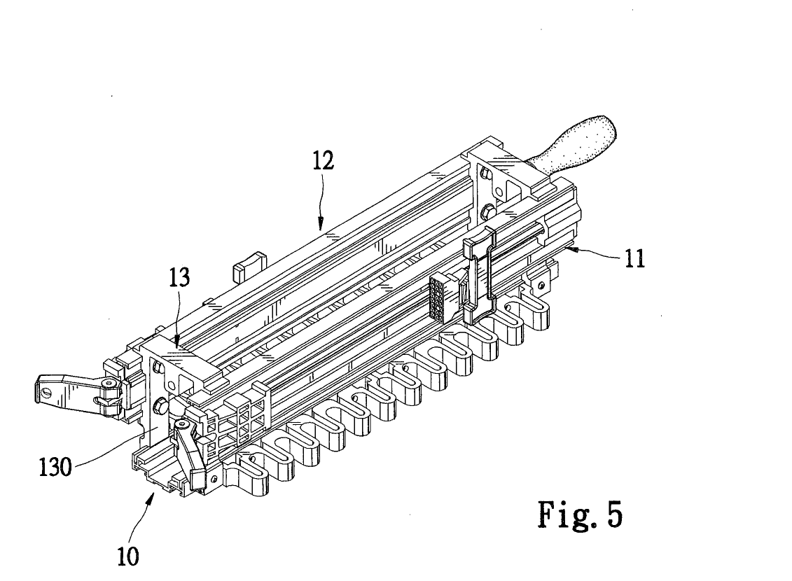

FIG. 5 shows a guide clamp system according to a second embodiment of the present invention. The second embodiment is identical to the first embodiment except for not using the stationary jaw 101, the movable jaw 102, the rod 107 and the lever 103 are removed from the body 100 so that the guide clamp system 1 can be stably put on a surface such as the workbench 30.

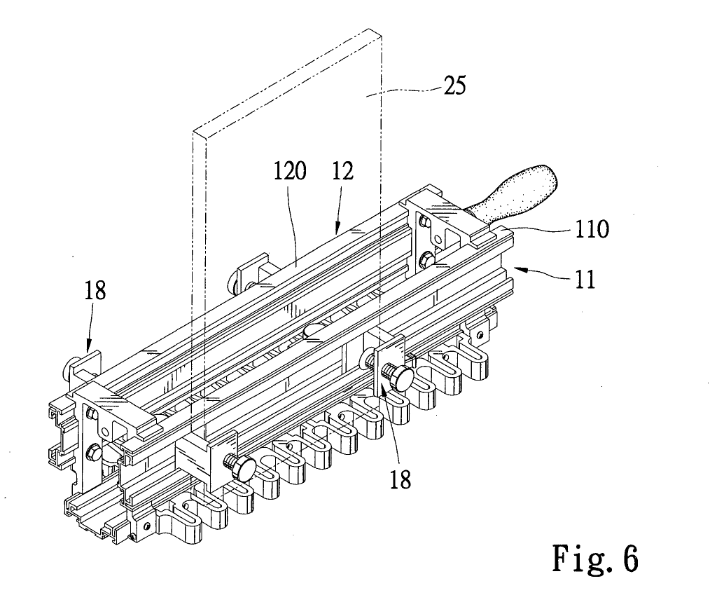

FIG. 6 shows a guide clamp system according to a third embodiment of the present invention. The third embodiment is identical to the first embodiment except for using C-clamps 18 instead of the stationary jaws 101, 111, 121 and the movable jaws 102, 112, 122.

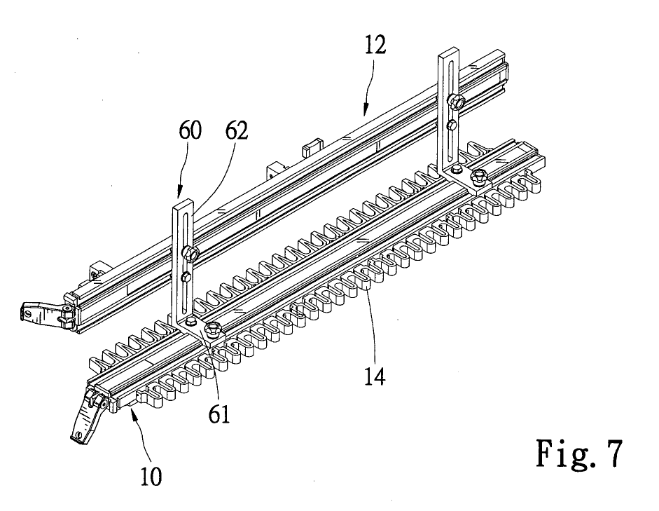

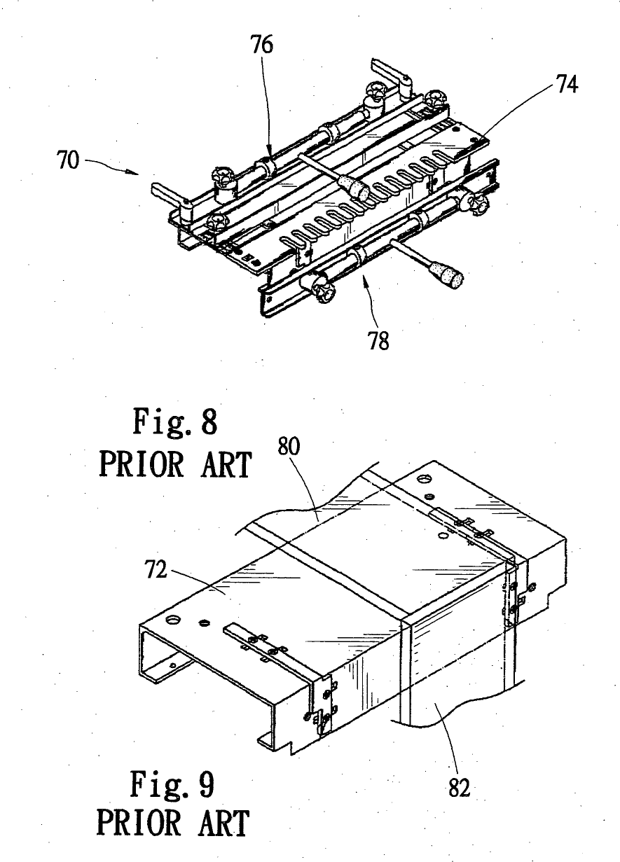

FIG. 7 shows a guide clamp system according to a fourth embodiment of the present invention. The fourth embodiment is identical to the first embodiment except for two points. Firstly, two connectors 60 are used instead of the connectors 13. Secondly, the guide clamp 11 is not used. Each of the connectors 60 includes a member 61 and a member 62 extending from the member 61. The guide clamp 10 is attached to the member 61 by means of a fastener (not numbered), and the guide clamp 11 the member 62.

The present invention has been described via detailed illustration of some embodiments. Those skilled in the art can derive variations from the embodiments without departing from the scope of the present invention. Therefore, the embodiments shall not limit the scope of the present invention defined in the claims.

1. A guide clamp system including at least two guide clamps and two connectors for connecting the guide clamps with each another.

2. The guide clamp system according to claim 1 wherein one of the guide clamps includes:
a body;
a stationary jaw secured to the body for contact with an edge a workpiece;
a movable jaw assembly movable on the body for contact with an opposite edge of the workpiece;
a rod movably attached to the body and inserted through the stationary jaw and the movable jaw assembly for selectively moving the movable jaw assembly; and
a lever pivotally connected with the rod for moving the rod.

3. The guide clamp system according to claim 1 wherein one of the guide clamps includes a body and two C-clamps attached to the body.

4. The guide clamp system according to claim 1 including a tool guide attached to the body of one of the guide clamp.

5. The guide clamp system according to claim 1 wherein each of the connectors includes a central member and two lateral members extending from the central member.

6. The guide clamp system according to claim 5 wherein each of the lateral members defines a recess for receiving an edge of the body of one of the guide clamp.

7. The guide clamp system according to claim 5 wherein each of the lateral members includes two tabs formed thereon, and the body of one of the guide clamp is put between the tabs of one of the lateral members.

8. The guide clamp system according to claim 7 wherein the tabs of one lateral member and the tabs of the other lateral member extend in opposite directions.

9. The guide clamp system according to claim 8 wherein the tabs of one lateral member extend away from the tabs of the other lateral member.

10. The guide clamp system according to claim 1 wherein each of the connectors includes a first member and a second member extending from the first member.
